(19) United States
(12) Patent Application Publication
(10) Pub. No.: US 2005/0072654 A1
(43) Pub. Date: Apr. 7, 2005

(54) Conveyor assembly

(76) Inventors: Markus Fraval, Burwood East Victoria (AU); Hadrian Fraval, South Warrandyte Victoria (AU); Marcus Cook, Park Orchards Victoria (AU); Don Erskine, Bendigo Victoria (AU)

Correspondence Address: BIRCH STEWART KOLASCH & BIRCH, PO BOX 747, FALLS CHURCH, VA, 22040-0747, US

(21) Appl. No.: 10/490,764

(22) PCT Filed: Sep. 26, 2002
(86) PCT No.: PCT/AU02/01318

(30) Foreign Application Priority Data
Sep. 27, 2001 (AU) PR 7938

(51) Int. Cl. B65G 47/14; B65G 47/91; B65G 47/32; B65G 47/256

(52) U.S. Cl. 198/443; 198/396; 198/689.1

(57) ABSTRACT

A conveyor assembly (1), including a main conveyor (4) with engagement means (30) for securing articles (26) at selected positions along the conveyor (4), the conveyor (4) being arranged to travel along a path where the articles (26) are subject to a displacement force which acts to remove any articles (26) that are not secured by the engagement means (30).

### FIELD OF THE INVENTION

The present invention relates to a conveyor assembly particularly, but not exclusively, for separating, single-filing and transporting articles such as plastic bottles and containers.

### BACKGROUND OF THE INVENTION

In the plastic bottle recycling industry, it is generally necessary to sort a batch of bottles by material type and colour. For that purpose, bottles are either scanned in random positions across a wide belt or are arranged in single file, with a suitable spacing therebetween, to allow the bottles to be identified and sorted, as appropriate. Single-filing results in greater control of identification and ejection and therefore greater sort accuracy/purity, but it is difficult to achieve at high throughput rates.

A known conveyor mechanism, for positioning the bottles in single file, utilises two elongated conveyors which are angled toward each other to form a “v”-shape, when viewed end-on, so that the bottles fall or roll into the centre of the “v”. One of the conveyors is driven at a faster speed than the other conveyor so that, for example, a bottle in side-by-side relation with another bottle may be accelerated in front of the other bottle, so as to adopt single file positioning. A third conveyor is provided, operating at a still faster speed, to receive the bottles one-by-one, from the first two conveyors. The increased speed of the third conveyor allows suitable spacing to be introduce between successive bottles.

Despite the above conveyor mechanism maximum throughout speeds of only 3 to 3.5 bottles per second are attainable since some problems still arise insofar as positioning of bottles. For example, some bottles may be in a flattened state and not able to roll into the centre of the “v”, which could result in overlap with other bottles. If the bottles are not properly centred, are too close to each other, overlap, or sit side-by-side, identification and sorting problems can occur.

### OBJECT

The present invention seeks to provide a conveyor assembly which avoids the above problems.

### SUMMARY OF THE INVENTION

In accordance with the invention, there is provided a conveyor assembly, including:
a main conveyor with engagement means for securing heterogeneous articles at selected, discreet positions along the conveyor, the conveyor being arranged to travel along a path where the articles are subject to a displacement force which acts to remove any articles from the conveyor that are not secured by the engagement means, wherein the engagement means includes a plurality of openings formed in a belt of the main conveyor, for suction engagement of the articles, in appropriate locations to space and single file the articles.

In another aspect, there is provided a conveyor assembly, including:
a main conveyor with engagement means for securing heterogeneous articles at selected, discreet positions along the conveyor, the conveyor being arranged to travel along a path where the articles are subject to a displacement force which acts to remove any articles from the conveyor that are not secured by the engagement means; and
a feed conveyor for delivering the articles to the main conveyor, wherein the feed conveyor includes a belt arranged in biased but moveable relation to the main conveyor, so as to allow passage of larger articles, and reliable presentation of different sized articles in adjacent or close proximity to the main conveyor, to assist the engagement means in securing the articles thereto.

Preferably, the engagement means includes a plurality of openings formed in a belt of the main conveyor, for suction engagement of the articles.

Preferably, the main conveyor is a vacuum conveyor or rotating vacuum drum. Alternatively, the main conveyor includes a non-rotating vacuum drum and a belt which moves about the periphery of the drum.

Preferably, the path is along an underside of the main conveyor or around an underside of the drum and the displacement force is gravity force. Alternatively, the belt of the main conveyor, along said path, is rotated about a longitudinal axis thereof so as to be angled away from the horizontal such that the articles are carried on a sloping surface and the displacement force is gravity force.

In practical embodiments of the invention, the feed conveyor may be a vacuum conveyor. Alternatively, the feed conveyor may be a baffle conveyor (typically a wide bed conveyor with baffles positioned along the conveyor's length and across the conveyor belt at an angle to the direction of travel, with the purpose of controlling the transverse position, and evening out the flow, of the conveyed material) or a chute to align and centre the articles relative to the main conveyor.

Preferably, articles which are removed from the main conveyor by the displacement force are recirculated to the feed conveyor and the assembly may further include a compactor, such as in the form of at least one roller drum to flatten the recirculated articles, prior to delivery to the feed conveyor.

In one instance, the assembly may include a sorting conveyor arranged to receive articles from the main conveyor, the sorting conveyor being arranged to travel at a faster speed than the main conveyor, in order to increase spacing between successive articles.

### BRIEF DESCRIPTION OF THE DRAWINGS

The invention is described in more detail, by way of non-limiting example only, with reference to the drawings, in which:

FIG. 1 is a diagrammatic side view of a conveyor assembly;

FIG. 2 is a diagrammatic side view of a main conveyor of the assembly of FIG. 1, shown in a tilted orientation; and

FIGS. 3a to 3c illustrate alternative arrangements of a conveyor assembly.

### DETAILED DESCRIPTION

A conveyor assembly 1 includes a vibratory feeder 2 which provides articles, such as plastic bottles or containers, to a feed conveyor 3, which in turn passes the articles to a main conveyor 4, for transfer to a sorting conveyor 5.

The main conveyor 4 has engagement means 30 for securing the bottles at specific positions relative thereto and, for that purpose, is preferably in the form of a vacuum conveyor which has a belt 6 provided with an arrangement of openings (not shown) along the length thereof, at preselected positions in order to allow for vacuum engagement of the articles.

In use of the assembly 1, the articles are delivered onto a top surface 7 of the feed conveyor 3, which is driven at the same speed as the main conveyor 4, in order to present the articles to the belt 6. The feed conveyor 3 may be a standard conveyor or a vacuum conveyor, but in either case, is preferably spring biased relative to the main conveyor 4 so as to accommodate different sized articles and to hold the articles in adjacent or close proximity to an underside 8 of the conveyor 4, to assist in securing the articles thereto.

The belt 6 then transports the articles over a space 9, where any articles which are not secured by vacuum engagement are subjected to a gravity displacement force and drop into a chute 10 for recirculation back to the feed conveyor 3 or another location. The belt 4 is preferably overfilled by the feed conveyor to ensure capacity loading of the main conveyor. The recirculated articles may be passed through a compactor (not shown) such as in the form of at least one roller drum to flatten the articles, prior to delivery to the feed conveyor 3, to increase the likelihood of subsequently being picked up by the conveyor 4.

The articles which remain engaged with the belt 6 are arranged in single file and, if required, with preselected spacing therebetween, at centralised locations corresponding to the openings in the belt 6. The predetermined positioning of the articles therefor allows for accurate and easy identification, such as by an automatic scanner so that the articles may be ejected, as appropriate, or delivered to the sorting conveyor 5, which is operated at a faster speed, to further separate the articles, if required, for additional sorting purposes. In order to ensure smooth transition of the articles the conveyors 4, 5 may be overlapped and/or inclined relative to each other.

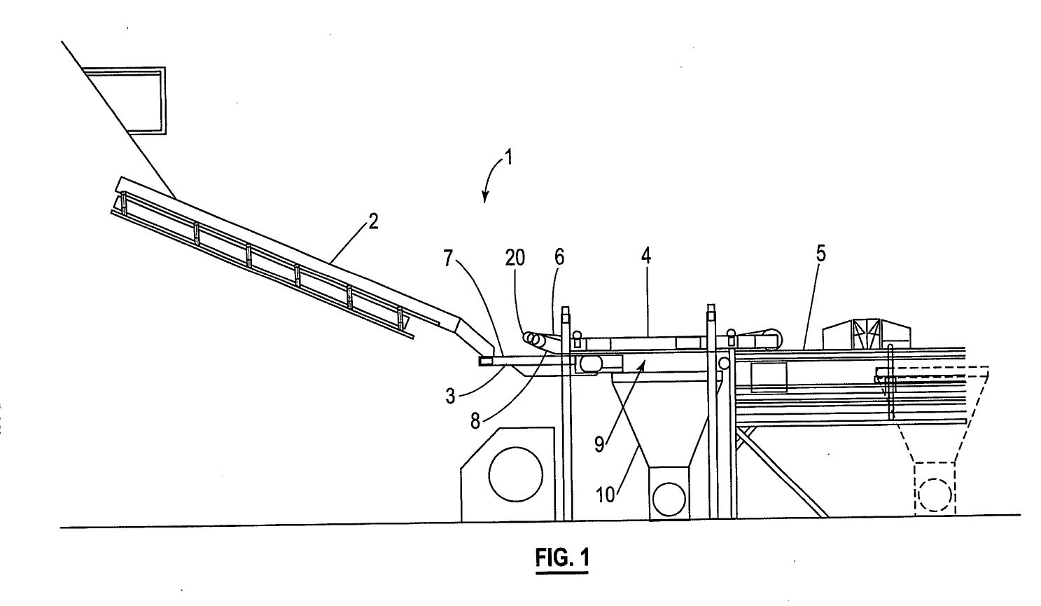

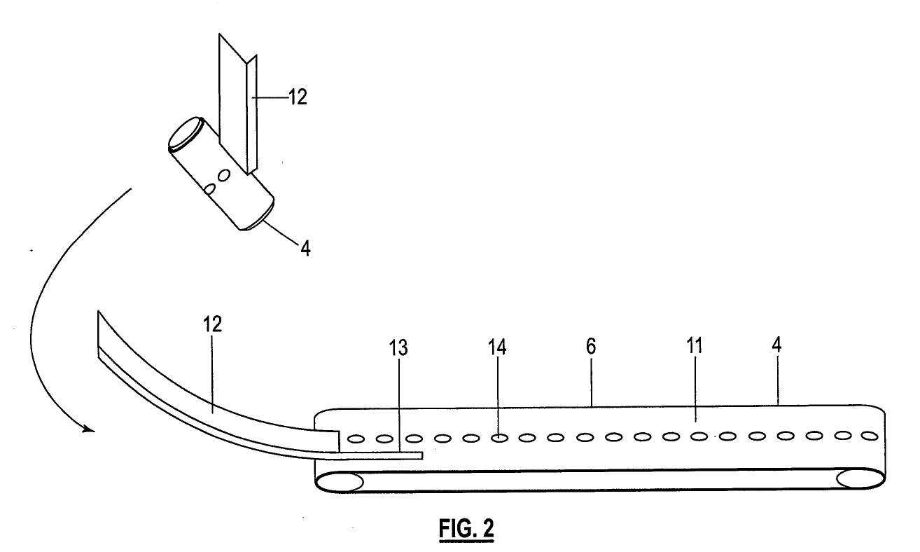

As an alternative to transporting the articles along an underside 8 of the conveyor 4, as shown in FIG. 1, the conveyor may alternatively be angled away from the horizontal and the articles may be supported on a sloping surface 11, as shown in FIG. 2. In that event, the articles may be fed to the belt 6 by way of a simple chute 12 which includes a ledge 13, from which the articles are introduced onto the conveyor 4. Again, any articles which are not engaged by suction through the relevant openings 14, slide down the face of the conveyor for subsequent recirculation. The belt is also relatively narrow to prevent any articles stacking up above those suctioned onto the conveyor 4. The openings 14 shown in the belt 6 are aligned centrally of the conveyor 4, however, any other suitable form and arrangement of openings may instead be utilised, as considered appropriate for the size and positioning requirements of the articles to be sorted.

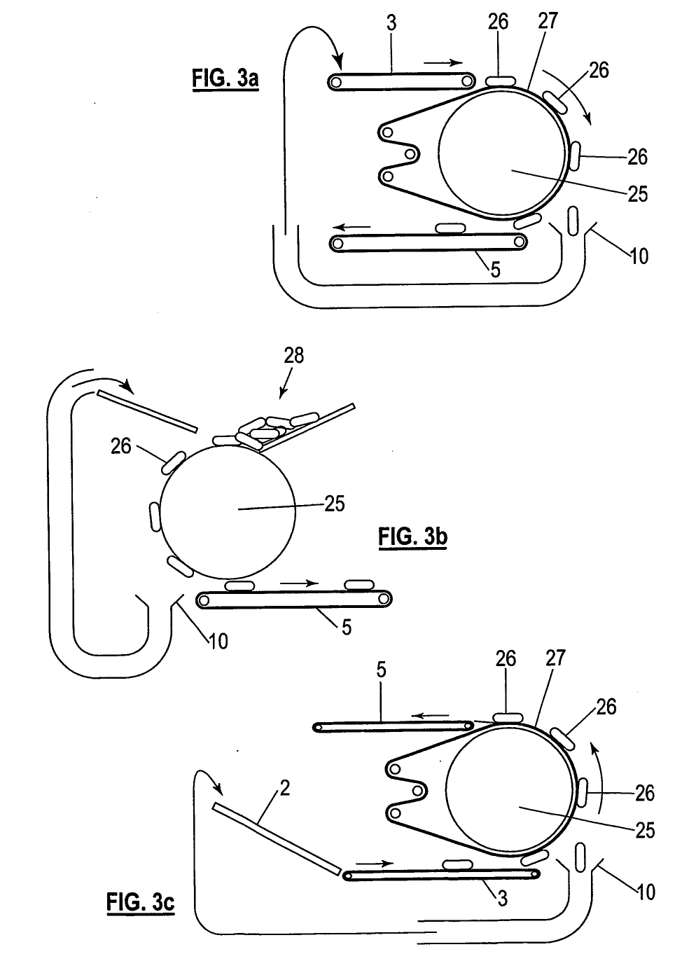

As a further alternative, the main conveyor 4 may be in the form of a rotating or non-rotating vacuum drum 25, as illustrated in FIG. 3, where like parts to those shown in FIGS. 1 and 2 are denoted by like reference numerals.

In FIG. 3a, the drum 25 is shown positioned below the feed conveyor 3 and above the sorting conveyor 5. The drum 25 shown in this arrangement does not rotate. Articles 26 are fed onto a belt 27 which passes over the drum 25 from the feed conveyor 3 and, as the belt moves about the drum 25, those articles which are not suction engaged with the belt 27, fall off the belt 27 under gravity, to be collected in chute 10 for feeding back onto the feed conveyor. A similar arrangement is shown in FIG. 3b, except that a feed conveyer is not utilised and the articles 26 are instead fed directly from a hopper 28 onto the drum 25 which in this case rotates.

As a further alternative, the sorting conveyor 5 may be positioned above the drum 25, with the feed conveyor below, as shown in FIG. 3c. In that case, the drum 25 does not rotate and the belt 27 is operated in a reverse direction to that shown in FIG. 3a, however, the same principle is applied insofar as the articles 26 suctioned to the belt 27 are transferred from the feed conveyor 3, about the periphery of the drum 25, to the sorting conveyor 5, while unattached articles are displaced from the conveyor and into the chute 10 under influence of gravity.

As may be appreciated from the above, the use of a conveyor with a predetermined arrangement of openings for vacuum suction of articles allows the positioning of the articles to be positively controlled. That, combined with the gravity force removal of any articles which are not appropriately positioned, allows the assembly to provide a very high quality and consistency of single filing which aids identification and, where appropriate, ejection of articles. That inturn leads to a reduction in problems caused as a result of non-single filed articles and, for sorting bottles, a higher throughput speed to be achieved, as compared to existing systems (up to 5 bottles per second or more). In addition, the assembly is able to achieve a relatively high level of single filing for a very heterogeneous mix of bottles, eg. for bottles ranging from 250 ml to 4 L in size and for all sorts of shapes. The use of gravity to remove all bottles that are not single filed and centred ensures very high consistency and control of bottles.

As such, the assembly 1 allows for handling of bottles of different materials and, even for fully co-mingled plastic input streams, can provide for accurate and cost-effective automatic sorting of plastic bottles.

The assembly has been described by way of non-limiting example only, and many modifications and variations may be made thereto without departing from the spirit and scope of the invention as hereinbefore described.

1. A conveyor assembly, including:
a main conveyor with engagement means for securing heterogeneous articles at selected, discreet positions along the conveyor, the conveyor being arranged to travel along a path where the articles are subject to a displacement force which acts to remove any articles from the conveyor that are not secured by the engagement means, wherein the engagement means includes a plurality of openings formed in a belt of the main conveyor, for suction engagement of the articles, in appropriate locations to space and single file the articles.

2. A conveyor assembly, including:
a main conveyor with engagement means for securing heterogeneous articles at selected, discreet positions along the conveyor, the conveyor being arranged to travel along a path where the articles are subject to a displacement force which acts to remove any articles from the conveyor that are not secured by the engagement means; and
a feed conveyor for delivering the articles to the main conveyor, wherein the feed conveyor includes a belt arranged in biased but moveable relation to the main conveyor, so as to allow passage of larger articles, and reliable presentation of different sized articles in adjacent or close proximity to the main conveyor, to assist the engagement means in securing the articles thereto.

3. A conveyor assembly as claimed in claim 2, wherein the engagement means includes a plurality of openings formed in a belt of the main conveyor, for suction engagement of the articles, in appropriate locations to space and single file the articles.

4. A conveyor assembly as claimed in any one of claims 1 to 3, wherein the main conveyor is a vacuum conveyor or rotating vacuum drum.

5. A conveyor assembly as claimed in any one of claims 1 to 3, wherein the main conveyor includes a non-rotating vacuum drum and a belt which moves about the periphery of the drum.

6. A conveyor assembly as claimed in claim 4 or 5, wherein the path is a long an underside of the main conveyor or around an underside of the drum and the displacement force is gravity force.

7. A conveyor assembly as claimed in any one of claims 1 to 3, wherein the belt of the main conveyor, along said path, is rotated about a longitudinal axis thereof so as to be angled away from the horizontal such that the articles are carried on a sloping surface and the displacement force is gravity force.

8. A conveyor assembly as claimed in claim 1, wherein the feed conveyor is a vacuum conveyor, baffle conveyor or chute to align and centre the articles relative to the main conveyor.

9. A conveyor assembly as claimed in claim 1, wherein articles which are removed from the main conveyor by the displacement force are recirculated to the feed conveyor.

10. A conveyor assembly as claimed in claim 9, further including a compactor to flatten the recirculated articles, prior to delivery to the feed conveyor.

11. A conveyor assembly as claimed in any one of claims 1 to 10, further including a sorting conveyor arranged to receive articles from the main conveyor, the sorting conveyor being arranged to travel at a faster speed than the main conveyor, in order to increase spacing between successive articles.
